(19) United States
(12) Patent Application Publication
(10) Pub. No.: US 2005/0216554 A1
(43) Pub. Date: Sep. 29, 2005

(54) Use of cache memory for decreasing the number of requests forwarded to server computers

(76) Inventors: Yehuda Meiman, Rishon Letzion (IL); Yiftach Shoolman, Modiyin (IL)

Correspondence Address: FROMMER LAWRENCE & HAUG, 745 FIFTH AVENUE- 10TH FL., NEW YORK, NY, 10151, US

(21) Appl. No.: 11/059,863

(22) Filed: Feb. 17, 2005

(30) Foreign Application Priority Data
Feb. 19, 2004 (IL) 160494

(51) Int. Cl. G06F 15/16; G06F 12/00

(52) U.S. Cl. 709/203; 711/118; 711/133

(57) ABSTRACT

A caching method for decreasing the number of access requests for object files that are forwarded from user computers to a server farm having computers operating with web-based applications via a network. A cache memory at the server farm function as an interface between the server computers and the network infrastructure, via which access requests are forwarded by the computers. The most current popular object files are stored in the cache memory; and the cache memory, in place of the server computers, accepts requests from one of the user computers for an object file. If the object file is stored in the cache memory it is forwarded to the requesting user computer; and if the object file is not stored in the cache memory, the request is forwarded to the server computers.

### FIELD OF THE INVENTION

The present invention relates to the field of Internet. More particularly, the present invention relates to a caching method for decreasing the number of access requests for object files that are forwarded from user computers to server computers farm, i.e. Internet website or any corporate data-center operating with web-based applications.

### BACKGROUND OF THE INVENTION

The Internet system comprises a plurality of websites that are normally hosted and operated by Internet Service Providers (ISPs) or by the website owners. The websites are configured to provide information/data services to Internet/Intranet users via the Internet and/or Intranet infrastructure. Because the Internet system is accessible essentially from everywhere in the world, situations in which a large number of users concurrently forward requests for information/data to a popular website are common. Websites tend to congest, as a result of their incapability to cope with a large number of requests that are concurrently forwarded to its web-servers. A partial solution to the problem of congestion is using, per website, a large number of web-servers such that essentially the same data, usually in the form of object files, is replicated and stored in the large number of web-servers. This way, the website can cope with a larger number of concurrent requests. However, adding more web-servers to a website gives rise to the overall cost of the hardware. In addition, another factor is to be considered, which is the ‘cost-per-request’. That is, there is a cost that is related to each request that is handled by web-servers. Using an increased number of web-servers does not solve the problem of ‘cost-per-request’ because it does not matter from which web-server a requested data is eventually fetched. In other words, one web-server or the other is still going to be occupied trying to cope with a specific request, and, therefore, the cost relating to a request remains the same (in comparison to a smaller number of web-servers).

Currently, cache memories are utilized in the Internet industry to reduce the communication bandwidth required by web-servers, and not to reduce the number of requests that are forwarded to the web servers. ISPs use cache memories as gateways to the global Internet infrastructure. These cache memories contain, among other things, object files that are determined as more popular than other object files. The popularity of an object file is determined according to one of several statistical methods that are commonly used in the Internet system, but, in general, by ‘popular object file’ is meant an object file that is concurrently requested by a large number of users. Whenever a user requests an object file, via an ISP, the content of the cache memory that is used by the ISP is scanned, and if the requested object file is found in the cache memory (RAM, or Disk), the object file is forwarded to the user from the cache memory. This way, there is no need for the ISP to search the whole Internet for the requested object file and, consequently, the communication bandwidth between the ISP and the global Internet can be kept reasonably narrow. Such a solution is described in, e.g., JP 10289219.

According to JP 10289219, a cache memory is operatively located between a local data network and a global data network. An example for a local data network is a Local Data Network (LAN) of an enterprise, and an example for global data network is the Internet system. Referring to the Internet system, the cache memory is used as a ‘gateway’ to the Internet infrastructure, and it includes object files that are mostly requested (i.e., highly popular) by users of the local data network. The more there are popular object files in the cache memory, the lesser is the communication required between the ISP and the Internet, and, consequently, the narrower is the communication bandwidth that is required therebetween. According to JP 10289219, the criteria, relating to which object file is to be stored in the cache memory, is directed to optimizing the communication bandwidth between the ISP and the global data network.

It is therefore an object of the present invention to provide a caching method that allows decreasing the number of access requests handled by web-servers of a website, and thus, the ‘cost-per-request’ relating to the website.

It is another object of the invention to provide a caching method that allows decreasing the number of web-servers in a website while maintaining the Quality of Service (QoS) of the website.

In this invention website also refers to enterprise data-center that uses web-based applications. And web-server can be a separated physical server or a software package which is integrated within an application server.

Other objects and advantages of the invention will become apparent as the description proceeds.

### SUMMARY OF THE INVENTION

The present invention provides a caching method for decreasing the number of access requests for object files that are forwarded from user computers to server computers of a website.

By ‘new object file’ is meant hereinafter an object file that is not currently stored in the cache memory at the time it is requested by a user computer.

The term ‘candidate for storing in the cache memory’ refers to an object file that is currently requested by a user computer but is not stored in the cache memory.

By ‘popular’ object file is meant to indicate an object file which is requested often by different users.

According to the present invention, decreasing the number of access requests is obtained by placing a cache memory in a strategic point, and an additional decrease in the number of access requests is obtained by storing, in the cache memory, popular object files in accordance with an optimal storage criterion, as described hereinbelow.

According to the invention, the cache memory is operatively located at the website or the corporate data-center who operates with web-base applications between the front-end of the computer farm servers and the router. The cache memory accepts, via the global Internet/Intranet infrastructure and in place of the server computers, requests from user computers to object files, and, if one or more of the requested object files are currently stored in the cache memory (i.e., for being popular), the one or more object files will be forwarded by the cache memory to the requesting user computer(s), whereby to save a corresponding number of requests from the server computers. Otherwise (i.e., the requested object file is not currently stored in the cache memory), the request is forwarded to the server computers to be handled by them, in which case the requested object file is retrieved from one of the server computers that is capable of handling the current request. The retrieved object file is, then, forwarded to the requesting user computer.

As noted hereinabove, this invention comprises also utilization of an optimal caching criterion for storing most popular object files. Being the most popular object files means that it is expected that more futuristic access requests will be related to these object files than to object files that are not, or relatively less, popular, and, therefore, more access requests will be responded, or treated, directly by the cache memory, which will forward the requested object files to the requesting user computers, substantially without the server computers being aware of the fact that the object files were requested by, and provided to (by the cache memory), user computers.

Whenever an object file is retrieved directly from a cache memory (rather than from one of the server computers), this results in the elimination of the need for the server computers to spend resources on the handling of the request relating to this object file.

As noted hereinabove, the present invention is also characterized by employing an optimal storage criterion Z=[P/S]*E, such that for each object file ‘n’ that is a candidate for storing in the cache memory, a caching priority ‘Zn’ is calculated. An object file ‘n’ will be stored in the cache memory if its ‘Zn’ value conforms to the criteria described hereinbelow. Each stored (in the cache memory) object file is assigned its calculated caching priority ‘Zi’, and the collection of the caching priority ‘Zi’ values form a group of caching priority values ‘Zi’ (Gcpv), where ‘i’=1 to m, ‘m’ being the number of object files that are currently stored in the cache memory.

As mentioned above, an object file ‘n’ will be stored in the cache memory if its Zn value conforms to the following criteria: Zn=[P/S]*E>Zth, wherein:
a) ‘Zn’ is the caching priority of a current new object file ‘n’ that is a candidate for storing in the cache memory;
b) ‘Zth’ is the smallest ‘Z’ value in a group (GCpv) of the caching priority values ‘Zi’;
c) ‘S’ is the “Size” of the file of object ‘n’ (in digital Bytes);
d) ‘P’ is the object's “Hit Probability” (also known in the art as “Occurrence Probability”), which refers to the popularity of object ‘n’, or, put otherwise, to the number of times an object file ‘n’ had already been requested by user computers during a recent interval. In some cases, the hit probability ‘P’ of objects is unknown, such as whenever object files are requested for the first time, or simply because specific object files are unknown. In such cases, these object files (some of which could be stored in the cache memory) can be assigned calculated current occurrence probability “P”, by utilizing the following exemplary equation:

$$P ( t ) = Default\_probability \cdot {\sum }_{i} exp ( ( {t}_{i} - t ) / factor )$$

Where
   t—current time
   tᵢ—time of “i” occurence
   factor—scaling factor and
e) ‘E’ is the “Expiration Time” (also known in the art as “Time to Live”), which is the time left from a current time to the calculated, or otherwise obtained, expiration time of object ‘n’. In cases where an expiration time ‘E’ of an object file ‘n’ is unknown, a default expiration time E is assigned to this object file according to the type of the object file.

If the above-mentioned criterion is met, with respect to a new object file ‘n’, (i.e., if Zn>Zth), the new object file ‘n’ will be stored according to one of the two following scenarios:
(a) if there is a sufficient storage place in the cache memory, the new object file (‘n’) will be stored in the cache memory without replacing anyone of the object files that are currently stored in the cache memory; otherwise, that is, if there is insufficient storage place in the cache memory for the new object file (for being larger than the available free storage place),
(b) The new object file (‘n’) will be stored in the cache memory after clearing for it enough storage place, in the cache memory, by removing one or more currently stored object files, the number of which depends on the size of the object ‘n’ and object files that are intended to be removed from the cache memory, and provided that each one of the object files has a caching priority value ‘Zi’ that is smaller than Zn, and the ‘Zi’ values of the object files are the smallest in G_{CPV}.

The actual number of the removed object files depends on the free storage space that is required for the storage of the new object file ‘n’, and on the size of each object file that is intended to be removed from the cache memory. If, however, the potential available storage place, which is expected to remain after the potential removal of all the object files whose ‘Zi’ values are smaller than ‘Zn’, is insufficient for storing the new object file ‘n’, the new object file ‘n’ will not be stored in the cache memory and the object files that were potential candidates for removal from the cache memory will not be removed.

If Zn>Zth (making the new object file ‘n’ a candidate for caching, as described above), but Zn is smaller than any of the smallest Z values of the currently stored object files, the new object file ‘n’ will not be stored (‘cached’) in the cache memory, due to it being inferior (e.g., not popular enough) relative to the object files that are currently stored in the cache memory.

### BRIEF DESCRIPTION OF THE DRAWINGS

In the drawings:

FIG. 1 schematically illustrates an exemplary conventional website; and

FIG. 2 schematically illustrates an exemplary website according to a preferred embodiment of the present invention.

### DETAILED DESCRIPTION OF PREFERRED EMBODIMENTS

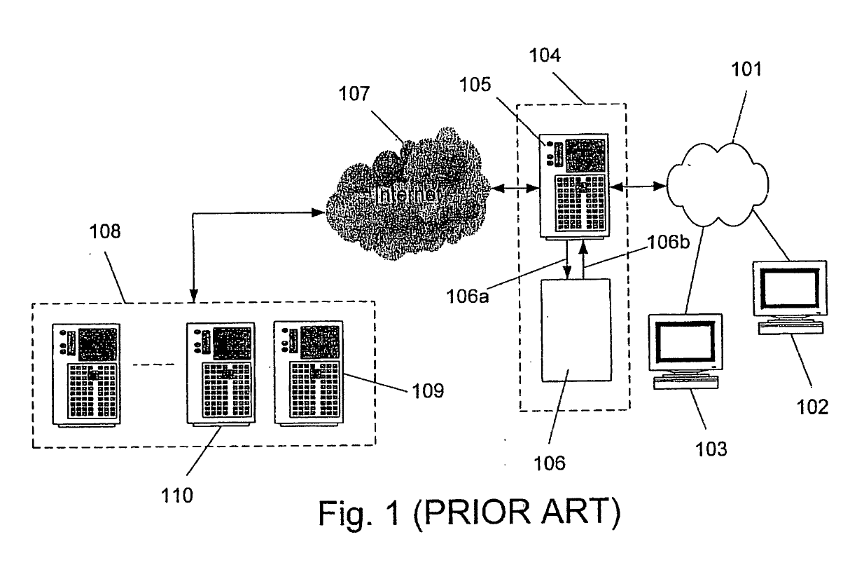

FIG. 1 schematically illustrates an exemplary conventional website. User computers 102 and 103 are connected, via local data network 101, to an ISP (schematically indicated as reference numeral 104), which serves as a gateway between local data network 101, which can be for example a Local Area Network (LAN) network, and the global Internet infrastructure (107). Server 105 of ISP 104 is configured, among other things, to accept requests for object files from user computers that are connected to local data network 101, for example, from user computer 102, seek and retrieve the requested object files from server computers belonging to website 108, and forward the requested files to the requesting user computer (102, pursuant to the example).

Each website normally includes several web server computers, each of which contains copies, or replicas, of the same object files, for allowing each website to handle a plurality of requests (for object files) that may be concurrently forwarded by a plurality of user computers. For example, website 108 includes a plurality of server computers, such as web-servers 109 and 110, and each one of the server computers of website 108 includes, among other things, the same object files.

In some cases, server 105 of ISP 104 is not connected to a cache memory, in which case every request that is forward to server 105 from users connected thereto via data network 101 (e.g., user 102) is forwarded to the plurality of websites that are part of the Internet system. Consequently, server 105 may become congested. In other cases, server 105 is conventionally connected to a cache memory such as cache memory 106, in which popular object files are stored. In the latter configuration, (server 105 being connected to cache memory 106), server 105 communicates with cache memory 106 (106a and 106b) every time a user, for example user 102, requests an object file. If the requested object file resides within cache memory 106, server 105 will retrieve the requested object file from cache memory 106 and forward it to the requesting user (e.g., 102). Otherwise, server 105 will forward requests to all the web-servers in the Internet. However, the presence of cache memory 106 has only insignificant effect on the number of requests that are eventually forwarded to server computers 109, 110, etc. of website 108 because of the enormous number of requests that can be concurrently forwarded to website 108 by other user computers in the Internet system, as described hereinbelow.

Because the storage capacity of cache memory 106 is very small comparing to the overall size of the entire object files existing in the Internet system, there are still a large number of requests that are eventually forwarded, via the Internet infrastructure 107, from ISP servers such as server 105 to websites such as website 108. Therefore, the servers of each one of the websites still have to cope with a large number of requests, which could cause, under sever circumstances, to congestion of the website.

Cache memory 106 may effectively decrease the number of the requests that are to be directly handled by web-servers only in cases where the users 102 and 103, and other potential users that may be connected to data network 101, request the same, and relatively small number of, object files. Should the latter scenario be the case, server 105 will seldom forward requests to the Internet websites. Unfortunately, this is not the case because of the small storage capacity of cache memory, as explained before.

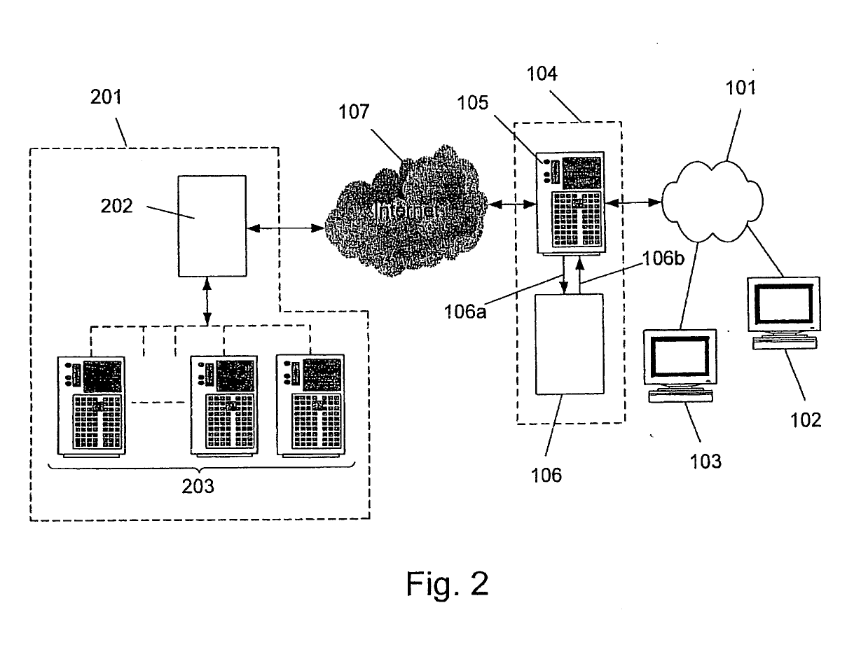

In order to effectively decrease the number of requests that are handled directly by web-servers of specific website(s), a cache memory is used as an intermediator between the web-servers of the specific website(s) and the Internet infrastructure, as is schematically illustrated in FIG. 2.

FIG. 2 schematically illustrates an exemplary layout of a website according to the principles of the present invention. Website 201 includes server computers 203 and cache memory 202. Cache memory 202 is functionally placed between servers 203 and the Internet infrastructure (107), and every request (for an object file) that is intended to website 201 is first forwarded to cache memory 202. If the requested object file is found in cache memory 202, cache memory 202 forwards it to the requesting user computer (e.g., user computer 102). Otherwise, cache memory 202 forwards the request further to one of the server computers 203, and if the requested object file is found in the addressed server computer 203, cache memory 203 retrieves the object file from one of server computers 203 and forwards it to the requesting user computer, via Internet infrastructure 107, and possibly stores a copy thereof in its memory. Put otherwise, if a currently requested object file, which is retrieved from one of the servers 203, is concurrently requested by several users, it might be found storable according to the criteria described hereinabove, and therefore, a copy thereof might be stored in the cache memory.

As described hereinabove in connection with FIG. 1, cache memory 106 (FIG. 1) has to cope with a very large number of object files that may reside in many different places in the Internet system, and, therefore, the contribution of cache memory 106 to the decrease in the number of requests that arrive to a website is minor. Referring again to FIG. 2, the functional location of cache memory 202 is very effective in decreasing the number of requests that web-servers 203 have to handle, because it is obvious that a website includes by far less object files than does the whole Internet system. Therefore, a relatively small-sized cache memory 203 can significantly minimize the need for cache memory 202 to forward requests to web-servers 203.

It has been found by the inventor of the current invention, that using the statistically-based decision criteria Zn=[P/S]*E>Zth for storing new object files in the cache memory further decreases the number of requests that otherwise would had to be handled by the web-servers.

In order to evaluate the performance of the cache memory according to the principles disclosed in the present invention, a simulation was made, which was based on a statistical model based on popularity and size distribution of a large number of object files. The results of the simulation are shown in table-1.

The caching criterion was Zn=[P/S]*E>Zth and the following assumptions were made in connection with the simulation:
a) The actual number of files was varied from 500,000 (0.5M) object files to 10,000,000 (10 M) object files;
b) The average size of the requested object files was 21 Kilo-Bytes (KB);
c) The distribution of the sizes of the object files was determined according to spec99 file distribution. A reference to spec99 file distribution can be made to: (1) SPECweb99.htm, and (2) http://www.spec.org/osg/web99.
d) The popularity of the object files was determined according to Zipf popularity statistics. A reference to which can be made to); (1) Managing TCP Connections under Persistent HTTP.htm http://www8.org/w8-papers/5c-protocols/policies/policies.html and, b) Characteristics of WWW Client-based Traces.htm, http://cs-www.bu.edu/faculty/crovella/paper-archive/TR-95-010/paper.html
e) The maximal storage capacity of the cache memory was varied from 0.5 Giga-B to 2 Giga-B; and

f) With respect to the ‘time to live’ criteria, whenever the lifespan of a cached object file expired, the object file was removed from the cache memory for allowing to store in the cache memory a new object file, provided that the new object meets the storage criteria. In general, small objects tend to expire earlier (i.e., they have shorter life span) than large objects. The lifespan of the cacheable objects ranged between minutes to days.

TABLE 1

| | | | | Total | BW |
|---|---|---|---|---|---|
| | Number of | Cache | Cache | Object Hit | Hit |
| | object files | Size | Objects | Probabiity | Probability |
| CASE | [×10⁶] | [GB] | [×10³] | [%] | [%] |
| A | 0.2 | 2 | 143 | 97.1 | 70.8 |
| | 0.5 | 2 | 259 | 93.9 | 58.9 |
| | 1 | 2 | 359 | 89.5 | 58.7 |
| | 2 | 2 | 482 | 86.6 | 52.3 |
| | 5 | 2 | 671 | 81.7 | 48.1 |
| B | 0.2 | 1 | 113 | 94.1 | 67.6 |
| | 0.5 | 1 | 181 | 89.6 | 57.1 |
| | 1 | 1 | 242 | 85.2 | 56.4 |
| | 2 | 1 | 311 | 82.6 | 47.5 |
| | 5 | 1 | 394 | 76.3 | 45.9 |
| C | 0.2 | 0.5 | 81.1 | 89.7 | 57.1 |
| | 0.5 | 0.5 | 121 | 85.5 | 49.4 |
| | 1 | 0.5 | 157 | 80.8 | 43.4 |
| | 2 | 0.5 | 192 | 76.5 | 44.5 |
| | 5 | 0.5 | 211 | 72.1 | 42.3 |

Referring to case A in Table-1, a cache memory having a storage capacity of 2 GB was used in the simulation, in which 143,000 (143 K) objects were stored from a total of 200,000 (0.2M) objects. It had been found that the probability to find a popular object file in the cache (i.e., the Hit Probability of the cached 143K objects) was 97.1%, meaning that despite the fact that 71.5% of the available objects (0.2M) were cached in the cache memory, the probability to find them in the cache was very high (97.1%).

Even in the worst case (case C, with 5M object files, in Table-1), where the maximum storage capacity of the cache memory was the smallest (i.e., 0.5 GB), and the total number of object files was the largest (i.e., 5M), the total object Hit probability was relatively large (72.1%), even though only 4.22% of the total number of object files (i.e., 211K object files of a total of 5M object files) were stored in the cache memory.

The implication of the results shown in Table-1 is that the number of requests that web-servers have to handle can be kept very small, because, as demonstrated by the results shown in Table-1, most of the requests will be directly addressed and fulfilled by the cache memory, without the web-servers being aware to these requests.

The above embodiments have been described by way of illustration only and it will be understood that the invention may be carried out with many variations, modifications and adaptations, without departing from its spirit or exceeding the scope of the claims.

1. A caching method for decreasing the number of access requests for object files that are forwarded from user computers to a server farm, the server farm having computers operating with web-based applications via a network, comprising the steps of:
using a cache memory at the server farm as an interface between said server computers and said network infrastructure, via which access requests are forwarded by said user computers;
storing most current popular object files in said cache memory;
accepting by said cache memory, in place of said server computers, a request from one of said user computers for an object file; and,
forwarding said object file to the user computer requesting said object file, if said object file is stored in said cache memory, whereby to decrease the number of access requests that are forwarded to said server computers; otherwise,
forwarding said request to the server computers if said object file is not stored in said cache memory.

2. A caching method according to claim 1, wherein the popular object files are stored in the cache memory according to the storage criteria:
Z=[P/S]*E>Zth,
Wherein:
‘Zn’ is the caching priority of a current new object file ‘n’ that is a candidate for storing in the cache memory;
‘Zi’ is the value of an individual object file currently stored in the cache memory, the collection of which forms a group G_{CPV};
‘Zth’ is the smallest ‘Z’ value in the group G_{CPV};
‘S’ is the “Size” of the file of object ‘n’; and
‘P’ is the object's “Hit Probability”, which refers to the popularity of object ‘n’,
wherein each currently stored object file is assigned its calculated caching priority value Zi, the collection of which forming a group of caching priority values (G_{CPV}); and wherein if said criteria is met with respect to a new object file ‘n’, said object file ‘n’ having a corresponding Zn value, said object file ‘n’ is stored in said cache memory according to one of the following:
a) said object file ‘n’ is stored in said cache memory without replacing anyone of the object files that is currently stored in said cache memory if there is a sufficient storage place in said cache memory; otherwise,
b) said object ‘n’ is stored in said cache memory after clearing for it enough storage place, in said cache memory, by removing one or more currently stored object files, the number of which depends on the size of said object ‘n’ and object files that are intended to be removed from said cache memory, and provided that each one of said object files has a caching priority value ‘Zi’ that is smaller than Zn, and the ‘Zi’ values of said object files are the smallest in G_{CPV}.

3. Method according to claim 1 wherein the access requests by the users to the server farm is made via the Internet.

4. Method according to claim 1 wherein the access requests by the users to the server farm is made via a wide area network.

5. Method according to claim 1 wherein the access requests by the users to the server farm is made via a local area network.

6. Method according to claim 1, wherein the server farm is a web site.

7. Method according to claim 1, wherein the server farm is a corporate data center operating with web-based applications.
